(19) United States
(12) Patent Application Publication
(10) Pub. No.: US 2008/0315551 A1
(43) Pub. Date: Dec. 25, 2008

(54) Motorcycle handlebar

(76) Inventor: Rikki Martin Battistini, San Ramon, CA (US)

Correspondence Address: Raymond Sun, 12420 Woodhall Way, Tustin, CA, 92782, US

(21) Appl. No.: 11/820,984

(22) Filed: Jun. 20, 2007

(51) Int. Cl. B62K 21/12; B62K 21/18

(52) U.S. Cl. 280/279; 74/551.8

(57) ABSTRACT

A motorcycle handlebar includes a main handlebar having a tubular body that has opposite ends, with a handle grip secured to each of the opposite ends. The handlebar includes a lower bar secured to the body and extending below the body, the lower bar secured to about the center of the body and having a length that is parallel to, and spaced from, the body.

### BACKGROUND OF THE INVENTION

1. Field of the Invention

The present invention relates to a custom handlebar for use with motorcycles.

2. Description of the Prior Art

The motorcycle market has always had a need for custom handlebars because every rider has a different physique. Each rider's arm length and height can vary, and there may be medical issues with certain riders that could restrict the movement of the rider. The position of the handlebar is important because the weight of the motorcycle requires that the rider be in good control to be able to hold up the motorcycle. As a result, different handlebar designs are needed to ensure that the rider has the most comfortable riding position.

Further complicating matters is the fact that most motorcycles have different widths between the mounting holes on the risers. This means that handlebars have to be made in different sizes to fit different risers.

A riser is a block that mounts to the top of the forks on a motorcycle, and acts as a clamp. This clamp holds the handlebar in a position that will allow for minimal adjustment by the rider to achieve a comfortable riding position. This clamp is usually mounted to the top of the forks by two fixing bolts and these bolts are spaced differently depending on the model of the motorcycle.

To address this problem, several manufacturers now offer different risers that have extra rise (to raise the handlebar) or pullback (to bring the handlebar back towards the rider) to assist the rider in obtaining the optimal riding position. Pullback is the distance from the top of the riser to the end of the handlebar along a straight line. Unfortunately, once the riser is fixed in place, the position cannot be altered without the purchase of another set of risers or handlebar.

Over the past ten years, a new “fatter” style of handlebar has become popular. However, new risers have to be provided to clamp the wider diameters of these “fatter” bars. Different manufacturers made different diameter handlebars, and had to make dedicated risers for each of these handlebars. To encompass a universal riser, some manufacturers have even reduced the center section of these handlebars to one inch to allow them to fit, but again this restricts the fit to certain models.

Another attempt to address these issues was to weld the risers directly on to the handlebars, thereby doing away with the conventional risers. Unfortunately, this is still not an optimal solution because different motorcycle manufacturers use different widths for the riser, so that a new set of handlebars will need to be designed for each motorcycle, and once again the rider would be fixed in his position once fitted as now there is no adjustment.

Handlebars are one of the main products that get changed on motorcycles after an owner takes delivery. The problem then rises that once the handlebar is fitted, the rider cannot vary the riding position very much (if at all). Therefore, should the rider purchase a lower seat, the handlebar fitted may not work and cannot be adjusted so that a new handlebar would need to be purchased.

Thus, there still remains a need for a handlebar assembly that can be adapted for use with most risers, and which provides improved and greater adjustability by the rider.

### SUMMARY OF THE DISCLOSURE

To accomplish the objectives set forth above, the present invention provides a motorcycle handlebar that includes a main handlebar having a tubular body that has opposite ends, with a handle grip secured to each of the opposite ends. The handlebar includes a lower bar secured to the body and extending below the body, the lower bar secured to about the center of the body and having a length that is parallel to, and spaced from, the body.

### BRIEF DESCRIPTION OF THE DRAWINGS

FIG. 1 is a perspective view of a motorcycle which includes the handlebar of the present invention.

FIG. 2 is a side view of a motorcycle which includes the handlebar of the present invention.

FIG. 3 is an exploded perspective view of a handlebar according to one embodiment of the present invention shown in use with one set of risers.

FIG. 4 is a front plan view of a portion of the handlebar of FIG. 3.

FIG. 5 is an exploded perspective view of the handlebar of FIG. 3 shown in use with a different set of risers.

FIG. 6A shows a conventional handlebar in the upright position on a motorcycle.

FIG. 6B shows the conventional handlebar pivoted backwards on a motorcycle.

FIG. 7A shows the handlebar of the present invention in the upright position on a motorcycle.

FIG. 7B shows the handlebar of the present invention pivoted backwards on a motorcycle.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

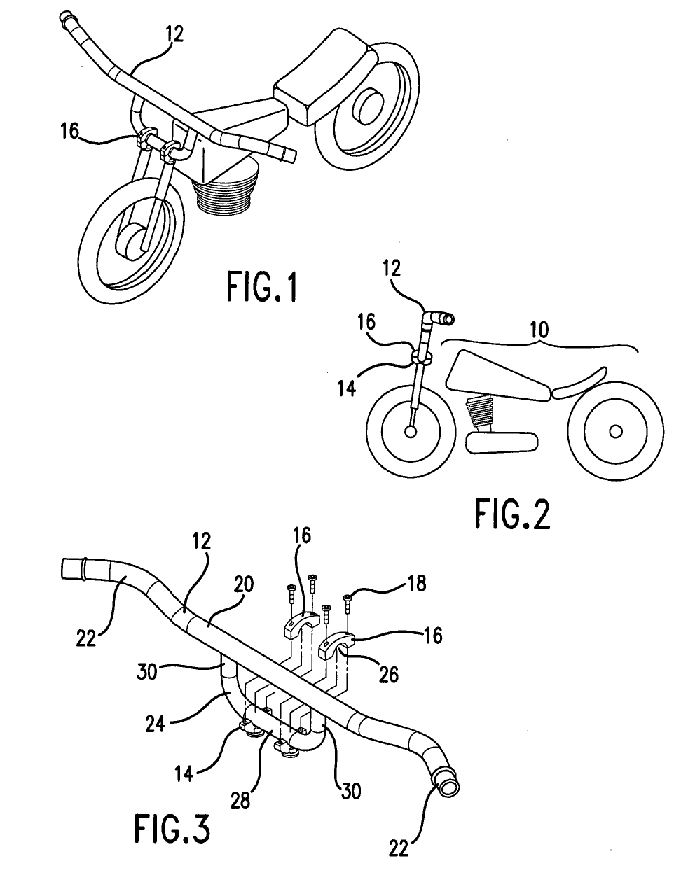

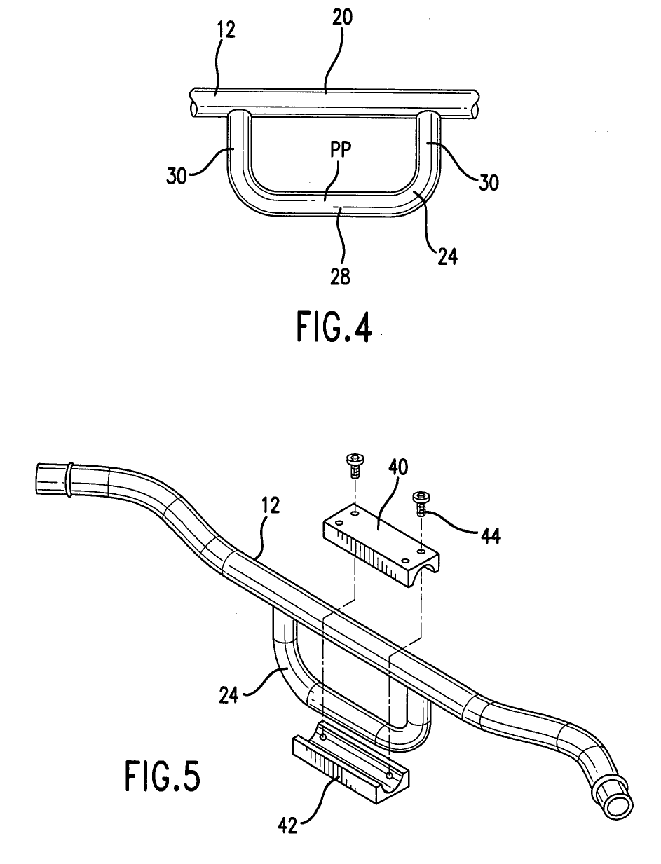

FIGS. 1 and 2 illustrate a motorcycle 10 that is provided with a handlebar 12 according to the present invention. The handlebar 12 is coupled to the motorcycle 10 by a pair of sets of risers. Each set of risers comprises a top piece 16 and a bottom piece 14 that are secured together via bolts 18. Each piece 14 and 16 defines a curved receiving space 26 that is adapted to receive a portion of a lower bar 24 when the pieces 14, 16 are secured together. As shown in FIGS. 1 and 2, the riser piece 14 can be secured to a fork on a motorcycle 10.

The handlebar 12 includes a main handlebar body 20 having handle grips 22 extending from both ends of the body 20. The shape and size of the body 20 and its handle grips 22 can be varied depending on the body size and other physical characteristics of the rider. A lower bar 24 can be attached to the center of the body 20 below the body 20, either via a permanent (e.g., welding) or a non-permanent (e.g., bolts) attachment. The lower bar 24 is generally U-shaped with a length 28 and two upward arms 30 which are secured to the body 20.

The lower bar 24 is sized and configured to encompass any riser of any width, and has a diameter which allows it to be used with any motorcycle. The length 28 of the lower bar 24 can be about 6 inches to accommodate most risers (whose lengths typically range between three inches and five and a half inches). In addition, the lower bar 24 can be made of tubular steel with a diameter of about one inch. The tubular construction allows wiring to run through the bore of the tubular lower bar 24 from the handlebar 12. The arms 30 are about one and a half inches to three inches long. The amount of pullback would vary depending on the distance of the lower bar 24 from the body 20. The amount of pullback needs to be enough to clear the top of the riser piece 16 and to also accommodate the added extra width of the handlebar 12.

The provision of the lower bar 24 allows for use with a handlebar 12 having any thickness. In addition, the extra height provided by the lower bar 24 allows for improved adjustment, and in particular, the backward and forward adjustment, as well as up and down movement, of the handlebar 12. This is accomplished because the lower bar 24 provides a different pivot point for pivoting the handlebar 12. The center of the lower bar 24 provides a pivot point PP about which the entire handlebar 12 is pivoted, whereas in a conventional handlebar, the pivot point would be at the center of the body 20. The pivoting or adjustment can be achieved by loosening the bolts 18 and then pivoting the handlebar 12.

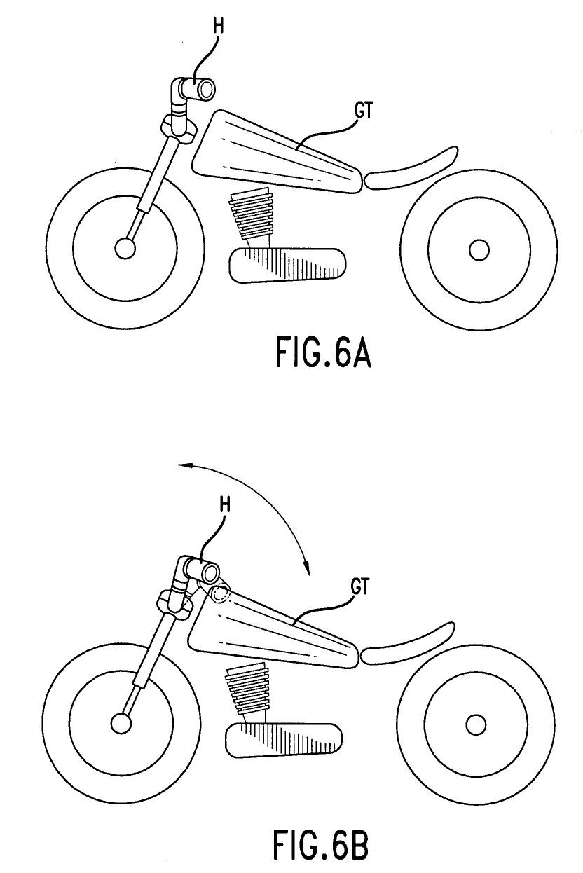

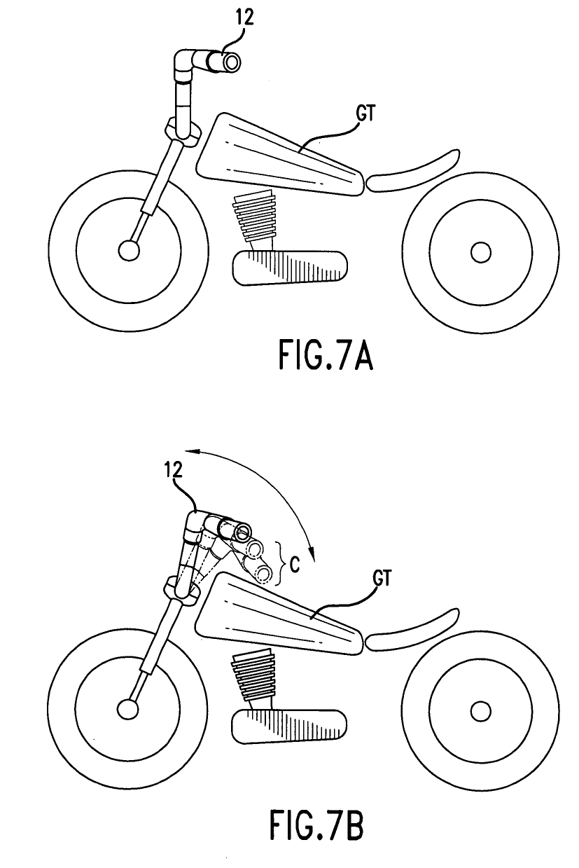

The improved adjustability offered by the handlebar 12 is best illustrated in FIGS. 6A, 6B, 7A and 7B. FIG. 6A shows a conventional handlebar H in the upright position, and FIG. 6B shows the conventional handlebar H pivoted backwards. FIG. 7A shows the handlebar 12 of the present invention in the upright position, and FIG. 7B shows the handlebar 12 pivoted backwards. When the handlebar positions are contrasted in FIGS. 6B and 7B, it is clear that the handlebar 12 provides for a greater range of adjustment, both up and down, and backwards and forwards. In addition, the lower bar 24 functions to raise the vertical level of the body 20 so that a clearance C (see FIG. 7B) is provided between the body 20 and the gas tank GT of the motorcycle. In contrast, as shown in FIG. 6B, the rearward adjustability of the conventional handlebar H is limited by the location of the gas tank GT. Yet another benefit accorded by the lower bar 24 is that the handlebar 12 visually looks like it is “floating” above the riser with the lower bar 24 hidden by the extra diameter of the handlebar 12.

FIG. 5 illustrates the same handlebar 12 and lower bar 24 used with a different set of riser pieces 40 and 42, that can be secured by bolts 44.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A motorcycle handlebar, comprising:
a main handlebar having a tubular body that has opposite ends, with a handle grip secured to each of the opposite ends; and
a lower bar secured to the body and extending below the body, the lower bar secured to about the center of the body and having a length that is parallel to, and spaced from, the body.

2. The handlebar of claim 1, wherein the lower bar further includes upwardly extending arms that are secured to the body.

3. The handlebar of claim 1, wherein the length of the lower bar is about three to five inches.

4. The handlebar of claim 1, wherein the length of the lower bar is spaced from the body by at least one and half inches.

5. The handlebar of claim 1, wherein the lower bar includes a pivot point for the motorcycle handlebar.

6. A motorcycle, comprising:
a pair of forks;
a handlebar having:
a main handlebar having a tubular body that has opposite ends, with a handle grip secured to each of the opposite ends; and
a lower bar secured to the body and extending below the body, the lower bar secured to about the center of the body and having a length that is parallel to, and spaced from, the body; and
a set of risers that has a top piece and a bottom piece, the bottom piece secured to one of the forks, with the lower bar received between the top and bottom pieces, and with the top and bottom pieces secured together.

7. The handlebar of claim 6, wherein the lower bar includes a pivot point for the motorcycle handlebar.
